(19) United States
(12) Patent Application Publication
(10) Pub. No.: US 2007/0250776 A1
(43) Pub. Date: Oct. 25, 2007

(54) Contents Index Structure, and Method and Apparatus for Demanding Contents Using the Same

(75) Inventors: Dong-Hoon Shin, Seoul (KR); Il-Ku Kang, Gyeonggi-do (KR); Soon-Hyun Kwon, Gyeonggi-do (KR); Jin-Hyuk Choi, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(73) Assignee: Bizkiz Corp., Seoul (KR)

(21) Appl. No.: 11/597,369

(22) PCT Filed: May 26, 2005
(86) PCT No.: PCT/KR05/01555

§ 371 Date: Nov. 22, 2006

(30) Foreign Application Priority Data
May 27, 2004 (KR) 10-2004-0037695

(51) Int. Cl. G06F 3/01

(52) U.S. Cl. 715/721

(57) ABSTRACT

A flat panel display apparatus includes a main plate, an organic light emitting element, a protecting layer and an attachable-detachable layer. The organic light emitting element includes a first electrode, a second electrode corresponding to the first electrode, and an organic light emitting layer disposed between the first and second electrodes to generate a light based on a current that flows between the first and second electrodes through the organic light emitting layer. The organic light emitting element is on the main plate. The protecting layer is on the organic light emitting element to protect the orgnaic light emitting element. The attachable-detachable layer is on the protecting layer. Therefore, an image display quality is improved, and a manufacturing cost is decreased.

### TECHNICAL FIELD

The present invention relates to a contents index structure, and a method and apparatus for demanding contents using the contents index structure. More particularly, the present invention relates to a contents index structure corresponding to a hot key for extracting contents stored in an optical disc, and a method and apparatus for demanding contents using the contents index structure.

### BACKGROUND ART

Generally, an optical disc player (ODP) irradiates a laser beam onto a disc such as CD, VIDEO-CD, CD-ROM, LD, DVD, etc., and detects the laser beam reflected by the disc to read out information stored in the disc. The above-mentioned operation is referred to as an ‘optical pick up’.

Recently, a DVD player receives a DVD disc having video/audio data encoded therein, and applies scrambled and decoded video/audio data to an apparatus such as a TV set.

The DVD player is operated through buttons formed at the DVD player or a remote controller. When the DVD disc contains many contents, a user extracts one of the contents by pressing the buttons several times.

Especially, it is hard for a small child who is not familiar with playing the DVD player to push the buttons several times.

### DISCLOSURE OF THE INVENTION

Technical Problem

The present invention provides a contents index structure corresponding to a hot key for extracting contents stored in an optical disc.

The present invention also provides a method for demanding contents using the above contents index structure regardless of a kind of an apparatus and a company manufacturing thereof.

The present invention also provides an apparatus performing the above method.

Technical Solution

The contents index structure according to an example of the present invention includes a first contents demanding key for extracting a first content, the first contents demanding key being mapped to a virtual point in order to define a reference, and other contents demanding keys arranged in a matrix shape such that a distance between the contents demanding keys and the virtual point increases.

The method for demanding contents, includes receiving a first content demanding signal corresponding to a specific content from a plurality of contents, generating a second content demanding signal in accordance with a combination of a plurality of direction buttons and an enter button based on a look-up table where a first contents demanding key is mapped to a virtual point in order to define a reference and other contents demanding keys are arranged in a matrix shape such that a distance between the contents demanding keys and the virtual point increases, and wirelessly sending the second content demanding signal.

The apparatus for demanding content, includes a contents key receiving section that receives a first content demanding signal corresponding to a specific content in a plurality of contents, a contents key-remote controller signal mapping section that includes a loop-up table where a first contents demanding key is mapped to a virtual point in order to define a reference and other contents demanding keys are arranged in a matrix shape such that a distance between the contents demanding keys and the virtual point increases, a remote controller signal extracting section that generates a second content demanding signal corresponding to a combination of a plurality of direction keys and an enter key based on the contents key-remote controller signal mapping section in response to the first content demanding signal, and a remote controller signal sending section that sends the second content demanding signal wirelessly.

According to the content index structure, the method for demanding contents and the apparatus for demanding content of the present invention, a hot key mapped to a combination of buttons corresponding to a content number is employed by a content output apparatus such as a DVD player to simplify an operation of the content output apparatus in order to extract contents.

### BRIEF DESCRIPTION OF THE DRAWINGS

The above and other advantages of the present invention will become more apparent by describing in detail exemplary embodiments thereof with reference to the accompanying drawings, in which:

FIG. 1 is a block diagram illustrating an apparatus for demanding contents according to an example of the present invention;

FIG. 2 is a diagram illustrating a contents index structure according to an example of the present invention;

FIG. 3 is a plan view illustrating conventional direction buttons and an enter button of remote controller;

FIG. 4 is a look-up table according to an embodiment of the contents index structure in FIG. 2;

FIG. 5 is a look-up table according to another embodiment of the contents index structure in FIG. 2; and

FIG. 6 is a plan view illustrating digit buttons and an enter button of remote controller according to the look-up table in FIG. 5.

### BEST MODE FOR CARRYING OUT THE INVENTION

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

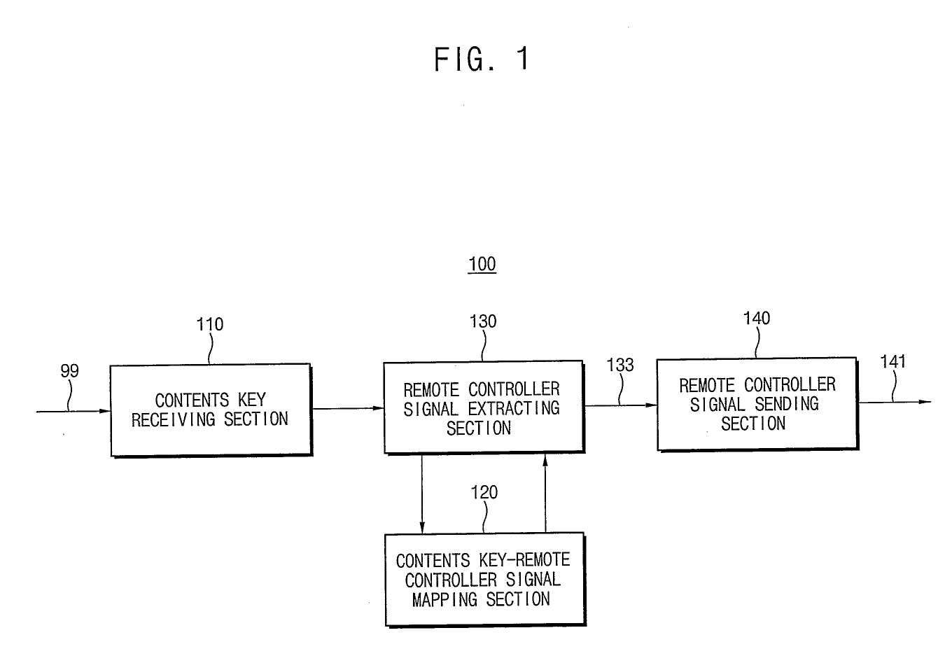

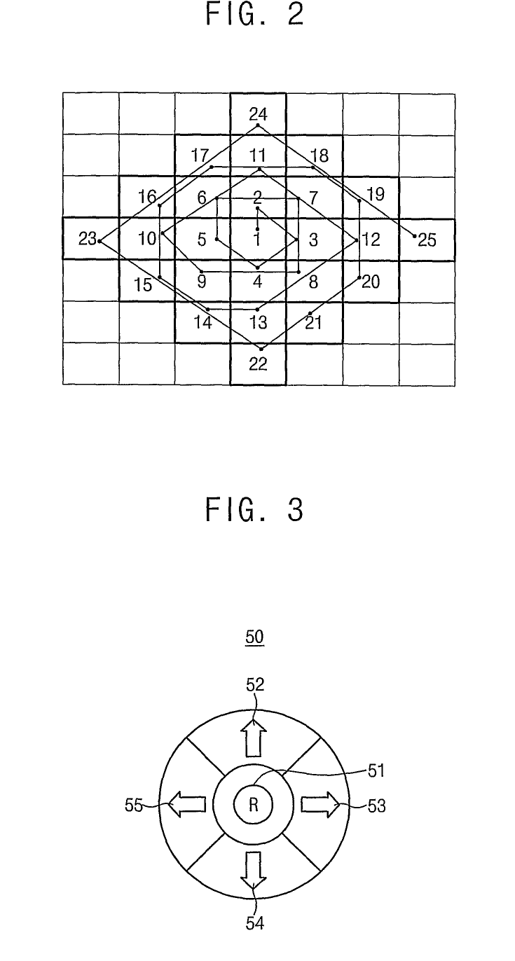

FIG. 1 is a block diagram illustrating an apparatus for demanding contents according to an example of the present invention. FIG. 2 is a diagram illustrating a contents index structure according to an example of the present invention. FIG. 3 is a plan view illustrating conventional direction buttons and an enter button of remote controller.

Referring to FIGS. 1, 2 and 3, a contents demanding apparatus 100 according to an example of the present invention includes a contents key receiving section 110, a contents key-remote controller signal mapping section 120, a remote controller signal extracting section 130 and a remote controller signal sending section 140. The contents demanding apparatus 100 receives a contents demanding signal and applies a hot key remote controller signal to a contents output device (not shown). The contents demanding apparatus 100 corresponds to an operational separation but not a physical (or hardware) separation.

The contents key receiving section 110 receives a first contents demanding signal 99 corresponds to a specific content among various contents and provides the first contents demanding signal 99 to the remote controller signal extracting section 130.

The contents key-remote controller signal mapping section 120 corresponds to a look-up table (LUT) according to increasing content numbers along an x-direction and increasing signal sequence along a y-direction, based on a contents index structure. The contents index structure in FIG. 2 includes a first contents demanding key 1 for extracting a first content, and other contents demanding keys, 2, 3, 4, . . . , 24, 25. The first contents demanding key 1 is fixed on a point of a virtual matrix and the contents demanding keys 2, 3, 4, . . . , 24, 25 are disposed along a clockwise spiral direction with respect to the first contents demanding key 1. In the figure, thirty two contents keys are illustrated.

In FIG. 2, the contents demanding keys are disposed along a clockwise spiral direction. Alternatively, the contents demanding keys may be disposed along a counter clockwise spiral direction. Furthermore, the contents keys may be mapped along increasing odd numbered line or column, and along decreasing even numbered line or column with respect to a virtual point. In other words, the contents keys may be mapped along a zigzag shape.

Alternatively, the contents demanding keys may be disposed such that a distance between the contents demanding key and a virtual point decreases, when an expectation value of selecting the contents demanding key increases.

The first contents demanding key is mapped to an enter button 51 of the remote controller 50, and other contents demanding keys are mapped to a combination of at least one of a first direction button 52, a second direction button 53, a third direction button 54 and a fourth direction button 55 along the increasing y-direction. The enter button is a key for an enter key of a remote controller corresponding to an optical disc player, or a key for selection.

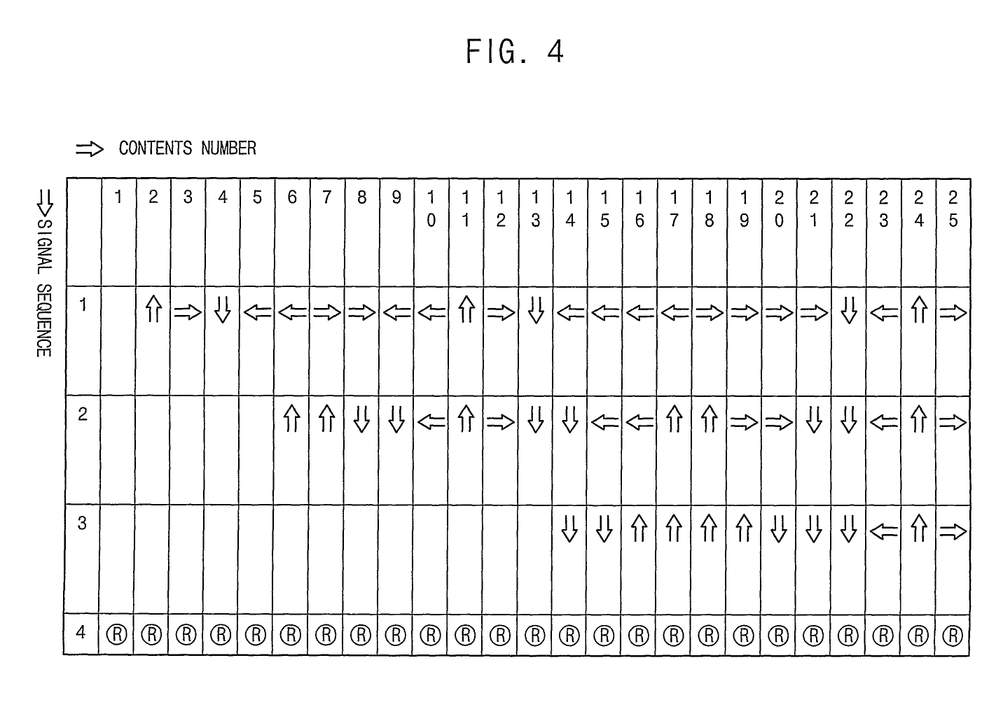

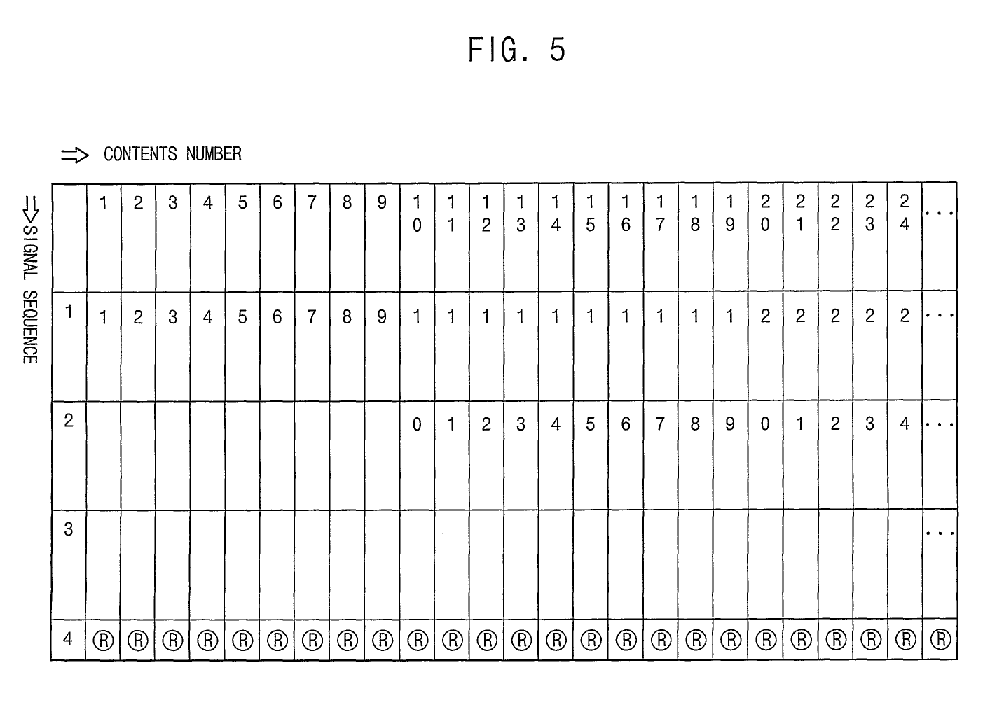

The contents key-remote controller signal mapping section 120 will be explained referring to FIG. 4.

The remote controller signal extracting section 130 provides the contents key-remote controller signal mapping section 120 with a remote controller signal-extracting signal in response to the first contents demanding signal 99, and provides the remote controller signal sending section 140 with a second contents demanding signal 133 corresponding to the combination of at least one of first, second, third and fourth direction buttons 52, 53, 54, 55 and the enter button 51.

The remote controller signal sending section 140 converts the second contents demanding signal 133 to a signal for wireless sending. The signal for wireless sending is applied to a contents output apparatus (not shown) such as DVD player. The DVD played by the DVD player, has a diameter that is substantially same as that of CD, but has higher capacity than the CD. The DVD may contain contents for video and audio. In detail, the DVD has eight audio tracks and thirty two sub tracks for multi language subtitles per a video track.

The DVD contains image data compressed in accordance with MPEG-2 standard, so that the DVD provides a high definition image. Additionally, the DVD contains audio data compressed in accordance with MPEG format and 5.1 channel of superior sound. Therefore, the DVD is used for storing contents of various fields such as movies, games, music videos, etc.

The DVD may contain contents for developing (or educating) imagination, arithmetical skills, speech, creation, chromatic sensitivity, morality and sociality of children.

In detail, when children plays with books or toys, contents of a DVD may be extracted through a DVD player in response to turning pages of the books or operating the toys.

As a multimedia education apparatus, a picture book for infants may be combined with multimedia technology. That is, contents corresponding to a picture in the picture book may be outputted as a moving picture or a sound through, for example, a television set. When the infant selects a specific portion of the picture, a contents corresponding to the selected specific portion may be outputted through the television set.

When a picture of a picture book is combined with moving picture and audio sound, a user interacts with the multimedia education apparatus, so that a gradational progress and repetitive learning may be obtained. Therefore, an effect of the multimedia education apparatus is maximized.

Additionally, a picture book and contents corresponding to the picture book may be formed in a package that may be replaceable. Therefore, the contents are evolved into many fields such as games, drawing pictures, writing and language repeating, as a result, an effect of the multimedia education apparatus is maximized.

FIG. 4 is a look-up table according to an embodiment of the contents index structure in FIG. 2.

Referring to FIGS. 2 through 4, a look-up table according to an example of the present invention includes a plurality of content demanding numbers 1, 2, 3, . . . , 24, 25 along an x-direction and a sequence of button along a y-direction.

The first content demanding number 1 corresponding to the first content demanding is mapped to the enter button 51, and other content demanding numbers, 2, 3, . . . , 24, 25 are mapped to a combination of at least one of the first, second, third and fourth direction buttons 52, 53, 54 and 55 and the enter button 51.

In detail, the second content demanding number 2 is mapped to a combination of the first direction button 52 and the enter button 51. The third content demanding number 3 is mapped to a combination of the second direction button 53 and the enter button 51. The fourth content demanding number 4 is mapped to a combination of the third direction button 54 and the enter button 51. The fifth content demanding number 5 is mapped to a combination of the fourth direction button 55 and the enter button 51. When a number of contents increases, a number of column also increases in order to increase a number of button.

The twenty fourth content demanding number 24 is mapped to the three of the first direction button 52 and the enter button 51. The twenty fifth content demanding number 25 is mapped to three of the second direction button 53 and the enter button 51.

According to the above-explained example of the present invention, each of the contents may be extracted by a contents demanding key based on a look-up table (LUT) storing hot keys corresponding to a combination of at least one direction button and the enter button.

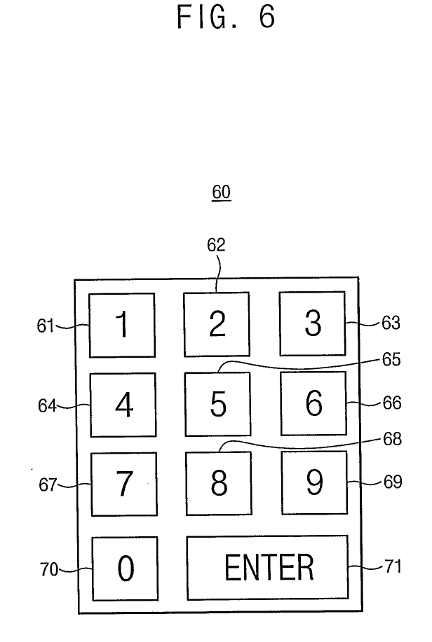

FIG. 5 is a look-up table according to another embodiment of the contents index structure in FIG. 2. FIG. 6 is a plan view illustrating digit buttons and an enter button of remote controller according to the look-up table in FIG. 5.

Referring to FIGS. 5 and 6, a look-up table according to another example of the present invention includes a plurality of content demanding numbers 1, 2, 3, . . . , 24, . . . along an x-direction and a sequence of signal along a y-direction.

The first content demanding number 1 corresponding to the first content demanding is mapped to the ‘1’ digit button 61 and an enter button 71. The second content demanding number 2 corresponding to the second content demanding is mapped to the ‘2’ digit button 62 and the enter button 71. The third content demanding number 3 corresponding to the third content demanding is mapped to the ‘3’ digit button 63 and the enter button 71.

Likewise, each of the content demanding numbers is mapped to a combination of keys based on the look-up table (LUT). When the content number increases, a number of column (or row) also increases. Therefore, a number of row (or column) for mapping a sequence of button also increases.

According to the example corresponding to FIGS. 5 and 6, a specific content is extracted by a hot key mapped to a combination of buttons based on the look-up table (LUT). Therefore, a remote controller may adopt above-mentioned example.

Having described the exemplary embodiments of the present invention and its advantages, it is noted that various changes, substitutions and alterations can be made herein without departing from the spirit and scope of the invention as defined by appended claims.

### INDUSTRIAL APPLICABILITY

According to the present invention, when a specific content is selected, the specific content may be extracted by a hot key corresponding to a combination of the direction buttons and the enter buttons or a combination of the digit buttons and the enter buttons. A remote controller may employ the hot key.

Children or infants may extract a specific content through the remote controller without help of a custodian or teacher.

1. A contents index structure comprising:
a first contents demanding key for extracting a first content, the first contents demanding key being mapped to a virtual point in order to define a reference; and
other contents demanding keys arranged in a matrix shape such that a distance between the contents demanding keys and the virtual point increases.

2. The contents index structure of claim 1, wherein the other contents demanding keys are arranged along a clockwise spiral direction or a counter clockwise spiral direction as contents numbers corresponding the contents demanding keys, respectively, increases.

3. The contents index structure of claim 1, wherein the other contents demanding keys are disposed such that a distance between the other contents demanding key and the virtual point decreases, when an expectation value of selecting the other contents demanding key increases.

4. The contents index structure of claim 1, wherein the first contents demanding key is mapped to correspond to an enter button of a remote controller, and the other contents demanding keys are mapped to a combination of the enter buttons and direction keys of the remote controller.

5. The contents index structure of claim 4, the other demanding keys are mapped to an increasing contents number such that a number of the direction button increases when the contents number increases.

6. The contents index structure of claim 4, wherein the first content demanding key and the other content demanding keys include the enter button.

7. A method for demanding contents, comprising:
receiving a first content demanding signal corresponding to a specific content from a plurality of contents;
generating a second content demanding signal in accordance with a combination of a plurality of direction buttons and an enter button based on a look-up table where a first contents demanding key is mapped to a virtual point in order to define a reference and other contents demanding keys are arranged in a matrix shape such that a distance between the contents demanding keys and the virtual point increases; and
wirelessly sending the second content demanding signal.

8. The method of claim 7, wherein the combination of the plurality of direction buttons and the enter buttons is obtained from the look-up table.

9. The method of claim 8, wherein the look-up table comprises a plurality of content numbers along a first axis and a sequence of signal along a second axis, the first content demanding key is mapped to the enter button, and other content demanding keys are mapped along an increasing direction of the second axis to a combination of at least one of first, second, third and fourth direction buttons and the enter button.

10. The method of claim 9, wherein a second content demanding key of the other keys is mapped to the first direction button and the enter button,
a third content demanding key of the other keys is mapped to the second direction button and the enter button,
a fourth content demanding key of the other keys is mapped to the third direction button and the enter button, and
a fifth content demanding key of the other keys is mapped to the fourth direction button and the enter button.

11. An apparatus for demanding content, comprising:
a contents key receiving section that receives a first content demanding signal corresponding to a specific content in a plurality of contents;
a contents key-remote controller signal mapping section that includes a loop-up table where a first contents demanding key is mapped to a virtual point in order to define a reference and other contents demanding keys are arranged in a matrix shape such that a distance between the contents demanding keys and the virtual point increases;
a remote controller signal extracting section that generates a second content demanding signal corresponding to a combination of a plurality of direction keys and an enter key based on the contents key-remote controller signal mapping section in response to the first content demanding signal; and
a remote controller signal sending section that sends the second content demanding signal wirelessly.
